(19) United States
(12) Patent Application Publication
(10) Pub. No.: US 2020/0204640 A1
(43) Pub. Date: Jun. 25, 2020

(54) PAGELISTS FOR JUST-IN-TIME TRANSMISSION OF DIGITAL DOCUMENTS

(71) Applicant: Microsoft Technology Licensing, LLC, Redmond, WA (US)

(72) Inventors: Pengfei Li, San Francisco, CA (US); Amol Chandla, San Francisco, CA (US); Valerie Tching, San Francisco, CA (US); Napat Luevisadpaibul, San Francisco, CA (US); Bao Long Nguyen Trong, Alameda, CA (US); Paul Jonathan Chavarria Podoliako, San Francisco, CA (US); Nicholas Robert Eric Eidler, San Francisco, CA (US)

(21) Appl. No.: 16/231,795

(22) Filed: Dec. 24, 2018

(51) Int. Cl. H04L 29/08; G06F 21/60

(52) U.S. Cl. CPC H04L 67/2842; H04L 67/06; G06F 21/602; G06F 2221/2143; G06F 2221/2107; G06F 2221/2125; G06F 2221/2137; G06F 21/604

(57) ABSTRACT

Techniques for just-in-time transmission of digital document files (e.g., word processing files, spreadsheet files, presentation files, etc.) using transfer protocols such as an HTTP compliant protocol. In one embodiment, a method includes transforming a digital document file into a plurality of distinct digital image files, and generating a pagelist file having a plurality of tags and uniform resource indicators (URIs) indicating an order of presentation of the plurality of digital image files. The plurality of digital image files and the pagelist file can be made available for serving to a client device which can retrieve the digital image files using the pagelist file.

### TECHNICAL FIELD

The disclosed implementations relate generally to serving digital documents over a data communications network, and, more particularly, to pagelists for just-in-time transmission of digital documents.

### BACKGROUND

Digital documents are generally transmitted from a server device as a single file and received by a client device as a single file. Presentation of the document content at the client usually does not begin until after the entire single file has been received at the client device from the document server. Further, typically the document content is available for download only in a single format, which may be sup-optimal for a particular client device environment which can vary among client device with respect display screen size, type of network connection with the server device, and current user interface state.

The techniques disclosed herein address these and other issues.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 illustrates an example client-server system, according to some implementations.

FIG. 2 is a flowchart of an example server process to support just-in-time transmission of digital documents, according to some implementations.

FIG. 3 is a flowchart of an example sever process to support just-in-time transmission of digital documents at different image resolutions, according to some implementations.

FIG. 4 is a flowchart of an example client process to support just-in-time transmission of digital documents, according to some implementations.

FIG. 5 is a flowchart of an example client process to support just-in-time transmission of digital documents at different image resolutions, according to some implementations.

FIG. 6 illustrates an example computer system in accordance with some implementations.

### DETAILED DESCRIPTION OF THE DRAWINGS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

### General Overview

In some implementations, techniques and components described herein can include mechanisms to deliver a just-in-time document transmission experience using transport protocols (e.g., HTTP) and other technologies (e.g., Joint Picture Experts Group (JPEG) image files). For example, just-in-time document transmission experience can be provided using HTTP to serve social network feed content, etc. Here, “just-in-time” refers to the ability provided by the techniques to transmit a portion of a document to a client device as and when or just before that portion is needed at the client device.

In some implementations, a protocol can transform an incoming digital document file into multiple digital image files and store those digital image files on a server. The protocol can also build a pagelist file that includes Uniform Resource Identifiers (URIs) that direct the client to the digital image files stored on a server. When the digital image files are presented in accordance with the pagelist file, the client can provide the user with a just-in-time document transmission experience.

In some implementations, the pagelist file allows the introduction of supplemental or alternative document content (e.g., advertisements, supplemental content, commentary, notes, annotations, comments, etc.). Additional URIs can be added to the pagelist file, the URIs may identify a location from which a client can download a supplementary file such as, for example, a file containing a text transcription of document content for client-side keyword indexing or text-to-speech accessibility presentation of document content. Another example of a supplementary file might be an audio or video media file containing advertising or commentary content that can be presented to the user at the user's client device.

In some implementations, the mechanism supports image resolution switching by providing different resolution digital image files of the same document portion (e.g., same page). For example, several versions of a document can be stored on a server. Each version can have substantially the same document content but rendered at different image resolutions. By doing so, the client device can switch between image resolutions depending on, for example, a detection of the available network bandwidth, without comprising just-in-time transmission of the document.

In some implementations, security features are provided to protect content from unauthorized access. For example, encryption of digital image files may be used. As another example, signed uniform resource indicators (URIs) may be used to refer to pagelist files and to refer to digital image files with pagelist files.

The implementations disclosed herein provide a number of improvements over existing approaches for digital document transmission depending on the implementation or combination of implementations that are used.

For one, because a digital document is transformed into multiple digital image files depicting different portions (e.g., pages) of the document in some implementations, a first portion (e.g., a first page) of the document can be downloaded and presented to the user sooner than if the entire digital document were to be downloaded first before presenting any portion of the document, thereby improving the user's document viewing experience and conserving network bandwidth resources between the user's client device and the document server.

For another, because multiple different resolution digital images depicting the same portion of a digital document are available for download in some implementations, the digital image at an image resolution that is most appropriate for the current client conditions can be selected by the client and then downloaded and presented to the user, thereby providing for more efficient utilization of computing and network resources. For example, if the user is viewing his or her social networking content feed in which document content is presented in the feed on his or her mobile phone having a relatively small display screen, then the client may select to a lower resolution digital image can be downloaded and presented the user in the feed, thereby conserving network bandwidth resources, without significantly affecting presentation quality (e.g., readability and visual clarity of the document content) given the small display screen, which may be especially important if the user's mobile phone is connected to the social networking service via a cellular network. On the other hand, if the user is viewing the same news feed on a larger desktop monitor, then a higher resolution digital image may be downloaded and presented to the user in the news feed that meets the user's expectations of presentation quality.

The multiple different resolution digital images also allow the client to dynamically switch between different resolution digital images depicting the same document content in response to user input in some implementations. For example, the client may initially download and present a lower resolution digital image of a document content portion when the user is viewing the user's social networking feed. Then, in response to the user directing input to the client device requesting to zoom in on the document content portion, a higher resolution digital image of the document content portion can be downloaded and presented to the user in the zoom mode where greater presentation quality may be expected by the user.

The pagelists are also extensible in some implementations. For example, in addition to providing URIs to digital images at different image resolutions, the pagelists can provide URIs to accessibility content or advertising content. For example, a pagelist can provide a URI to a text transcription of the document content portion such that the client can use the URI to download and use the text transcription. Such use may include, for example, keyword indexing for keyword searching document content and/or text-to-speech presentation of document content.

Implementations providing these and other improvements are described in greater detail below.

### Client-Server System

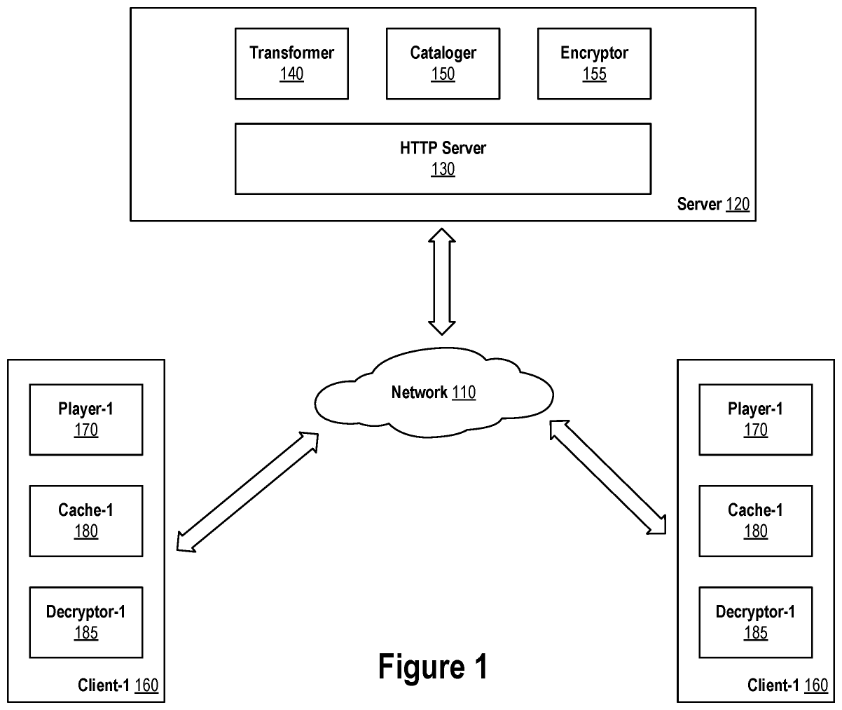

FIG. 1 is a block diagram of a server and clients that can send and receive just-in-time document content, according to some implementations. In FIG. 1, two clients are coupled with a server via a network. However, any number of clients may be supported utilizing the techniques and mechanisms described herein. Further, multiple servers may provide content and/or may operate together to provide content according to the techniques and mechanisms described herein. For example, one server may transform digital document files into digital image files, another server may serve the pagelist files to the clients, and yet another server may serve the digital image files.

In some implementations, the pagelist files and/or the digital image files are served by a content delivery network. In these implementations, uniform resource indicators (URIs) to pagelist files and/or uniform resource indicators (URIs) within pagelist files to digital image files may refer to server or servers of one or more content delivery networks where the pagelist files and/or the digital image files are stored and served from to clients.

In some implementations, for extra security, uniform resource indicators (URIs) to the pagelist files and/or uniform resource indicators (URIs) to the digital image files are signed. A signed URI is a mechanism by which a content delivery network or other server can probabilistically ensure that only authorized clients are able to access a protected resource (e.g., document content) requested by the signed URI. In some implementations, a signed URI contains or is associated with (e.g., in a browser cookie) a cryptographically signed token that can be verified with a cryptographic key that is known to the content delivery network and the content service provider but unknown to clients. In some implementations, a signed URI is associated with a client's network address or a range or a set of client network addresses that restricts which network clients can access the protected resource using the signed URI. In addition, or alternatively, a signed URI may be associated with a time window (e.g., an expiration time, a start and end time, or a time-to-live) that restricts when network clients can access the protected resource using the signed URI. Unless the context clearly indicates otherwise, reference to a “uniform resource indicator (URI)” in this description can be substituted with “signed uniform resource indicator (URI)” without loss of generality.

Network 110 can be a wired or wireless (e.g., an IEEE 802.11 WLAN network) network, or a combination of a wired and wireless network, or any network that supports the transport protocol (e.g., HTTP). For example, network 110 may be the Internet or an intranet. As another example, network 110 may a cellular network (e.g., a GSM or a CDMA network).

In some implementations, client devices 160 are capable of communicating over multiple network types. For example, client devices 160 may be capable of communicating over a wireless local area network and also over a wireless cellular network. For example, client devices 160 may be smart phone or cellular-enabled personal computing devices that are configured to communicate over cellular networks as well as wireless local area networks.

While in some implementations client devices 160 are capable of communicating over a cellular network, client devices 160 are not so capable in other implementations. For example, client devices 160 may be tablet computing devices or other type of computing device that is capable of communication over a wireless local area network but not configured to communicate over a cellular network. In some implementations, client devices 160 are capable of communication over a wired communications network (e.g., an IEEE 802.3 network) but not capable of communicating over a wireless communication network. For example, client devices 160 may be desktop or laptop computing devices that are configured to communicate over wired Ethernet. Further, client devices 160 need not all the same type of electronic device and client devices 160 may include different types of electronic devices. For example, client devices 160 may include a mix of portable electronic devices such as smart phones and tablet computers and relatively more stationary computing device such as desktop and workstation computers.

Server 120 may operate as a HyperText Transfer Protocol (HTTP) server. Accordingly, server 120 may include a HTTP server 130 that provides content using the HTTP protocol. While in some implementations server 130 is an HTTP server, server 130 is another type of server that implements a like protocol such as, for example, the secure HyperText Transfer Protocol (HTTPS), the file transfer protocol (FTP), secures shell file transfer protocol (SFTP), or the like.

Transformer 140 and cataloger 150 are agents that reside on server 120 (or multiple servers) to provide document content in digital image files with a pagelist file. The digital image files and pagelist files may be provided over network 110 via HTTP servers 130 or other servers using HTTP or other suitable protocol. Agents can be implemented in hardware, software, firmware, or a combination thereof.

Transformer 140 may be configured to transform (e.g., paginate) document files into multiple digital image files that may be transmitted via HTTP protocols. Cataloger 150 may be configured to create pagelist files corresponding to the transformed document files so that client devices can present the digital image files to provide just-in-time transmission of document content provided by server 120. Server 120 may further include optional encryptor 155 that provides encryption for digital image files produced by transformer 140.

In response to one or more requests from a client device, HTTP server agent 130 (or other servers) may transmit one or more pagelist files as generated by cataloger 150 and digital image files of document content as generated by transformer 140.

Client devices 160 may receive the pagelists files and digital image files from server 120 over network 110. Client devices 160 can include a document player 170. Document player 170 can receive the pagelist files from server 120 and use the pagelist files to access and download digital image files from server 120. Document player 170 uses the downloaded digital image files to generate visible output from the respective client device. The visible output may be provided one or more display screens that are part of and/or coupled to the respective client device. In some implementations, document player 170 is implemented, at least in part, in a scripting language interpretable by a web browser application or the like at the client devices 160. For example, document player 170 may be implemented, at least in part, in JavaScript or other ECMAScript-based scripting language and/or the HyperText Markup Language (e.g., HTML 5). In other implementations, document player 170 is implemented, at least in part, as a more standalone application such as, for example, a mobile application implemented, at least in part, in the Java, Objective-C, Swift, C++ or other application programming language.

Client devices 160 can also include storage media provide local image cache 180 to store downloaded digital image files as they are received. The local image cache 180 can provide many pages or portions worth of document content before or after the page or pages or portion or portions of document content currently being presented such that the locally cached digital image files can be displayed later while new digital image files are being downloaded from server 120. This local cache 180 can provide presentable document content while the client device 160 is downloading or attempting to download additional digital image files over a slow or intermittent network connection, thereby temporarily masking/hiding network latency or connectivity problems from the end user.

Client devices 160 may further include optional decryptor agent 185 for decrypting digital image files encrypted by encryptor 155.

### Just-In-Time Document Transmission

In some implementations, techniques disclosed herein are used to transmit pages of document content in the form of digital image files using the HTTP protocol. Because individual digital image files can be transmitted upon request, the pages of document content can be received and presented just-in-time. While certain example data formats for files as well certain actions taken by a server and a client are described herein, other data formats may be supported, and different actions taken.

In some implementations, a document that can be transmitted just-in-time is specified by a universal resource indicator (URI) that indicates a pagelist file. In some implementations, the pagelist file is an ordered list of additional URIs. Each additional URI in the pagelist file refers to a digital image file that contains a digital image of a page, a section, or other portion of the document.

In some implementations, in order to present a document, a client device obtains the pagelist file for the document from the server. The client device also obtains and presents digital image files referred to in the pagelist file.

### Pagelist File

In some implementations, a pagelist file is a text file containing, among other things, the network locations of one or more digital image files containing content (e.g., pages) of the document. For example, the pagelist file may be, for example, a javascript object notation (JSON) file, an extensible markup language (XML) file, or a file containing data formatted according to another predetermined text or character-based data interchange format.

In the examples that follow, a pagelist format is utilized for a document that includes a PAGES tag. The PAGES tag may be associated with a list or set of one or more URIs in the pagelist file for the document. Each URI refers to a digital image file representing a portion (e.g., page or section) of a document. In some implementations, each digital image file URI is individually associated with a PAGE tag in the pagelist file for the document. In either case, a set of digital image file URIs for the document may be ordered within the pagelist file according to a presentation order. For example, the digital image file URI for the first page of the document may appear in the pagelist file before the digital image file URI for the second page of the document which in turn may appear in the pagelist file before the digital image file URI for the third page, and so on.

In some implementations, a digital image file URI or a list or set of digital image file URIs is associated in a pagelist file with a RESOLUTION tag which specifies the pixel resolution of the digital image file(s) referred to by the URI(s) associated with the RESOLUTION tag. Here, pixel resolution generally refers to the number of effective pixels of the digital image as measured, for example, by a number of megapixels, by a number of pixels per length unit by a number of pixels per width unit, or a number of pixels per area unit (e.g., pixels per inch). Instead of a single tag specifying the pixel resolution, a PAGE tag or a PAGES tag may be associated with multiple tags specifying the pixel resolution. For example, a PAGE tag or a PAGES tag may be associated with (1) a WIDTH tag and (2) a HEIGHT tag that specifies (1) the pixel resolution by a number of pixels per width by (2) a number of pixels per length unit, respectively. Thus, the pagelist file can provide different sets or lists of digital image URIs representing the same pages of the same document at different image resolutions.

Each digital image file URI in a pagelist file can have a unique sequence number. The sequence number, if present, of a digital image file URI can be equal to an initial sequence number (e.g., zero or one) or equal to the sequence number of the digital image file URI that precedes it in presentation order plus one, in some implementations. In some implementations, the sequence numbering is non-sequential to provide a simple form of content protection.

In some implementations, digital image files are encrypted. A KEY tag may be used in a pagelist file to provide information that can be used to decrypt digital image files. For example, the value associated with the KEY tag may specify the encryption method and a URI that refers to the encryption key.

In some implementations, a value of NONE for the KEY specifies no encryption. If encryption is used, various encryption methods may be used including, but not limited to, AES-128. If AES-128 is used as the encryption method, various different information items can be used to seed the initialization vector when decrypting a digital image file including, but not limited to, the sequence number or presentation order number of the digital image file.

In some implementations, a digital image file URI or a list or set of digital image file URIs is associated in a pagelist file with a CACHE tag which specifies whether the associated digital image file(s) can be stored (cached) locally for later presentation. For example, the CACHE tag may be associated with a Boolean value that specifies whether the associated digital image file(s) are allowed to be cached (stored) locally for later presentation.

In some implementations, a digital image file URI or a list or set of digital image file URIs is associated in a pagelist file with a CACHE_TTL that indicates a time window during which the associated digital image file(s) may be cached (stored) locally for later presentation. For example, the value of a CACHE_TTL tag may be a time-to-live value relative to a base time (e.g., a current time or a time of download), an expiry time, or a combination of a start time and an end time that specifies the time window. In some implementations, the time window is indicated by the value of the CACHE tag and the CACHE_TTL tag is not used. In these implementations, if there is no CACHE tag or the value of CACHE tag is zero or null or the like, then this may be taken as a specification that the associated digital image file(s) are not allowed to be cached (stored) locally for later presentation. Alternatively, in some implementations, if there is no CACHE tag or the value of the CACHE tag is zero or null, then this may be interpreted as a specification that the associated digital image file(s) can be cached indefinitely for later presentation so long as there is available storage space in the local cache to store the image file(s). In this case, if the local cache becomes full, existing image file(s) can be evicted on a least recently used/accessed/downloaded basis to make room for more recently used, accessed, or downloaded image file(s).

The foregoing tag names such as PAGES, RESOLUTION, CACHE, etc. are examples only are not intended to be limiting as to the names for the tags. Other names with the same or equivalent semantics may be used according to the requirements of the particular implementation at hand.

While in some implementations the information described above that may be included in a pagelist file is included in a single file, the information is spread over multiple files in other implementations. For example, an additional “master” file may be created for a document and that master file may refer to multiple pagelist files for the document where each of the pagelist files contains digital image file URI(s) at different image resolutions.

For example, the following master file in JSON format for a document refers to two pagelist files for a document where each pagelist files contains URIs referring to digital images files at different image resolutions. In one pagelist file for the document, the digital image files referred to by URIs in that pagelist file are at a resolution of 1280 pixels in width by 720 pixels in height. In the other pagelist file for the document, the digital image files referred to are at a lower resolution.

00: {
01: ″pageLists″: [
02: {
03: ″width″ : 1280,
04: ″height″ : 720,
05: ″pageListURI″
06: : ″https://abc.xyz.com/pagelist/B4EAQEQZAkPrJDQ4A/feedshare-
doc_720/0?e=1491429297&v=1&t=Q1AM0694Z_
qCaJ0r3GNPszU6WE397ZtCx5k07t1Kdis″
07: },
08: {
09: ″width″ : 640,
10: ″height″ : 360,
11: ″pageListURI″
12: : https://abc.xyz.com/pagelist/B4EAQEQZAkPrJDQ4A/feedshare
doc_360/0?e=1491429297&v=1&t=Q1AM0694Z_
qCaJ0r3GNPszU6WE397ZtCx5k07t1Kdis
13: }
14: ]
15: }

The following is an example pagelist file containing digital image URIs:

00: ″pages″ : [
01:
″https://abc.xyz.com/playback/B55AQHFNpIOhPJ8QA/
c5c2d60ddc234ba5914ceb20dea5e9bc/feedshare-
doc_720/1.jpeg?e=1523408964&v=beta&t=
6WgMTKcj0renL7fhQYV0bOWk0jS4R9nVp9h9HIQ6NNo″,
03:
″https://abc.xyz.com/playback/B55AQHFNpIOhPJ8QA/
c5c2d60ddc234ba5914ceb20dea5e9bc/feedshare-
doc_720/2.jpeg?e=1523408964&v=beta&t=
wQ2IpFccRvJaZu8ZEPTNvX8iFwgG9oota_WcbUDyQ80″,
04:
″https://abc.xyz.com/playback/B55AQHFNpIOhPJ8QA/
c5c2d60ddc234ba5914ceb20dea5e9bc/feedshare-
doc_720/3.jpeg?e=1523408964&v=beta&t=
rzzNlm0kgj2dEjVfRrJBA9g57sZqct3N3wcjivyi2_8″,
05:
″https://abc.xyz.com/playback/B55AQHFNpIOhPJ8QA/
c5c2d60ddc234ba5914ceb20dea5e9bc/feedshare-
doc_720/4.jpeg?e=1523408964&v=beta&t=PRbofV3NViOO4kD3s_
e308hKYF7-kwmayCT-6Ow2OJk″
06: ]
07: }

In the above-examples of JSON formatted information, line numbers followed by a colon character are used to designate different lines. These line numbers are provided for purposes of providing a clear example in this detailed description and may not actually be used in a given implementation.

The foregoing tags and attributes can be used by the server device to organize, transmit and process the document files that represent the original document content. The client devices use this information to reassemble and present the document files in a manner to provide a just-in-time document presentation experience (e.g. presenting a page or pages of a document in a social network news feed) to a user of the client device.

In some implementations, each digital image file URI in a pagelist file identifies a digital image file that is an image of a portion (e.g., a page, a section, or other portion) of the original document. In some implementations, each digital image file is formatted/encoded according to a common image format such as, for example, TIFF 6.0, GIF 89a, JPEG/JFIF, JP2-JPX/JPEG 2000, Flashpix 1.0.2, PNG 1.2, PDF 1.4, or the like. The digital image format of the digital image files can be specified in the pagelist file by specifying a MEDIA TYPE or a MIME TYPE, or a compatible format may be assumed by default. In some implementations, all digital image files for a document have the same digital image format. However, multiple digital image formats may be used in other implementations.

### Example Server Processes

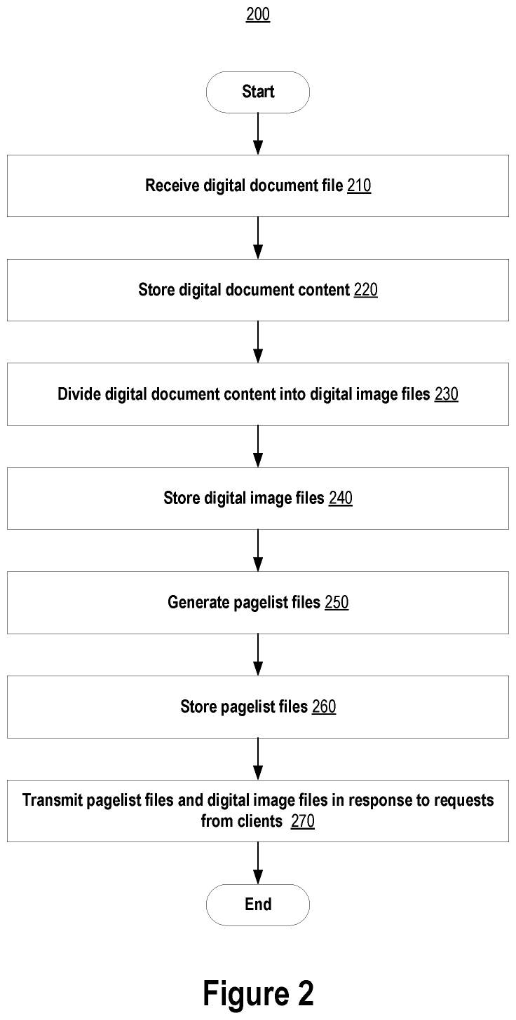

FIG. 2 is a flowchart of a process 200 performed by one or more server devices to support just-in-time transmission of documents, according to some implementations. HTTP is used as the transport protocol in the example process 200. However, other transport protocols (e.g., HTTPS, FTP, SFTP, etc.) may be used in other implementations. The example process 200 is described as being performed by a single server device. However, multiple server computers may be used in other implementations. For example, one set of one or more servers may provide the digital image files and another set of one or more servers may transform digital documents into digital image files and the two sets of server computers may partially overlap or be mutually exclusive.

The server receives a digital document file to be provided in operation 210. The content of digital document file may represent a variety of different types of content including, but not limited to, word processing content, speadsheet content, text and graphic presentation content, web page content, etc. The digital document file may be received by the server in a variety of different standard or propriety document data formats including, but not limited to, .csv, .doc, .docm, .epub, .numbers, .ods, .odt, .otf, .pdf, .ps, .rtf, .ttf, .xls, .xlsx, as just some examples.

The server may then store the content or at least portions (e.g., pages) of the document content in operation 220. The content or at least portions of the content may be stored temporarily, for example, on a storage device (e.g., hard disk in a Storage Area Network, etc.) or in memory. Alternatively, the content may be received via a storage medium (e.g., compact disc, flash drive) from which the content may be transferred to a storage device or memory. In one embodiment, the server has a transformer that transforms, if necessary, the original document file in an original document data format into an intermediate document data format (e.g. PDF) from which digital image files can be created on a portion by portion basis (e.g., on a page by page basis). For example, this transformation can occur by converting the original document file content to the intermediate document data format using a virtual print driver or the like that is configured to print the original document file content in the intermediate document data format. This transformation can occur without storing permanently the received content, and in some implementations, the storage operation 220 may be omitted or it may be a longer-term storage (e.g. an archival storage) in other implementations.

In operation 230, the document content to be provided is divided into multiple digital image files. In some implementations, the server transforms the original document content into separate and distinct digital image files that can be distributed separately and individually using HTTP or the like. In some implementations, the server divides the document content into multiple digital image files by page where each digital image file contains the content of a single page of the document. The server may also create a URI for each digital image file. The URIs allow client devices to access the digital image files.

The digital image files may be stored in the server memory at operation 240. The digital image files can be protected by encryption in conjunction with storing the files in operation 230. The digital image files, either encrypted or unencrypted, may be stored such that are capable of being transmitted using HTTP or the like from an HTTP server or the like.

At operation 250, one or more pagelist files are generated to indicate the order in which digital image files should be presented to recreate the original document content. The pagelist file(s) can utilize JSON or XML tags or the like to provide information for a client device to present the digital image files and provide a just-in-time document presentation experience at the client device. In some implementations, a URI for each digital image file is included in the pagelist file(s) in the order in which the digital image files are to be presented. The server can also create one or more URIs for the pagelist file(s) to allow the client devices to access the page list file(s).

The pagelist file(s) are stored on the server in operation 260. While the generation and storage of digital image files and pagelist file(s) are presented in a particular in FIG. 2, a different order may be used. For example, the pagelist file(s) may be created before the digital image file(s) are generated or stored. As another example, the pagelist file(s) and digital image files may be generated before either are stored.

The server can transmit the pagelist file(s) and the digital image files over the network in response to client requests in operation 260. In some implementations, a server transmits the pagelist file to a client device in response to receiving a request from a client device for a pagelist file. The client device may request the pagelist file using a URI that has been provided to the client device. The URI may indicate the location of the pagelist file on the server. In response, the server may provide the pagelist file to the client device over the network. The client device may then utilize tags and URIs in the pagelist file to access digital image files.

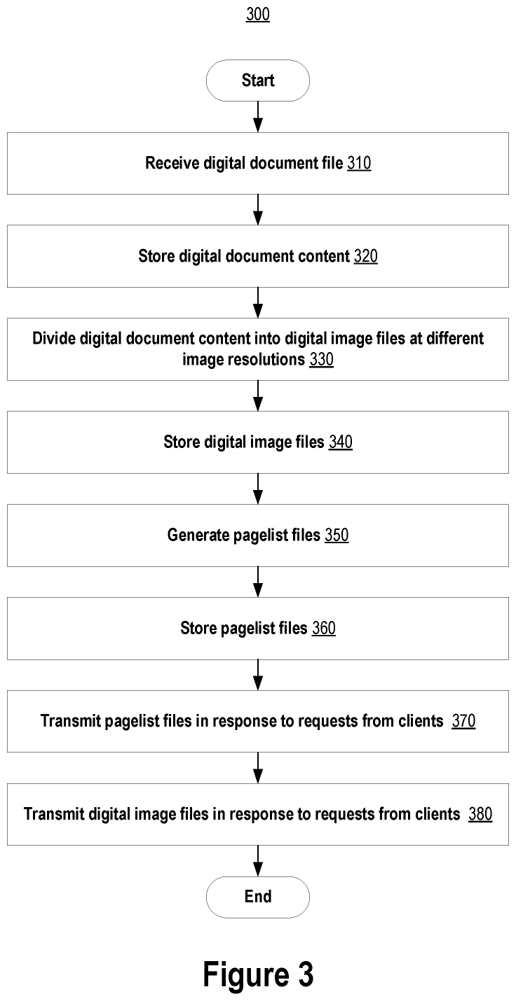

FIG. 3 is a flowchart of an example server process 300 to support just-in-time transmission of document content at different image resolutions, according to some implementations. HTTP is used as the transport protocol in the example process 300. However, other transport protocols (e.g., HTTPS, FTP, SFTP, etc.) may be used in other implementations. The example process 300 is described as being performed by a single server device. However, multiple server computers may be used in other implementations. For example, one set of one or more servers may provide the digital image files and another set of one or more servers may transform digital documents into digital image files and the two sets of server computers may partially overlap or be mutually exclusive.

In some implementations, the server can offer multiple pagelist files or a single pagelist file with multiple digital image file lists in the single pagelist file to provide different image resolutions of the same document content. If the different image resolutions are provided, pagelist file(s) may include URIs for each different image resolution to allow client devices to switch between image resolution dynamically.

Referring to FIG. 3, the server device receives document content to be provided in operation 310. The server may then at least temporarily store the document content in operation 320. The document content to be provided is divided into multiple digital image files in operation 330. Each digital image file is at a selected image/pixel resolution and stored on the server in operation 340. For example, the digital image files may be targeted for high-, medium- and low-bandwidth connections, or small-, medium-, and large-display screen sizes, or small-, medium-, and large-web page viewport sizes. The digital image files can be encrypted prior to storage. The rendering of the digital image files targeted for the various types of network connections, screen sizes, and/or viewport sizes may be selected to provide a document presentation experience at a target bandwidth, a target display screen size, and/or target viewport size.

In some implementations, a pagelist file is generated at operation 350 with URIs referring to digital image files at different image resolutions. The pagelist file can include URIs to digital image files for the various different image resolutions. Thus, a client device can select a target image resolution from the alternatives provided in the pagelist file and retrieve the corresponding digital image files.

In some implementations, a master pagelist file is generated at operation 350 with URIs referring to different pagelist files for different image resolutions. Thus, a client device can select a target image resolution from the alternatives provided in the master pagelist file and retrieve the corresponding pagelist file.

The pagelist file or the master pagelist file indicating the various different image resolutions is stored on the server at operation 350. If a master pagelist file is used, each of the pagelist files referenced in the master pagelist file can also be generated and then stored at operation 350.

In response to a request from a client device, the server may transmit the master pagelist file or the pagelist file that indicates the various image resolutions in operation 370. The server may receive a request for one of the pagelist files specified in the master pagelist file corresponding to a selected image resolution at operation 370. In response to the request, the server transmits the corresponding pagelist file corresponding to the request from the client device in operation 370. The client device may then use the pagelist file to request digital image files from the server. The sever provides the digital media files to the client device in response to requests in operation 380.

### Example Client Processes

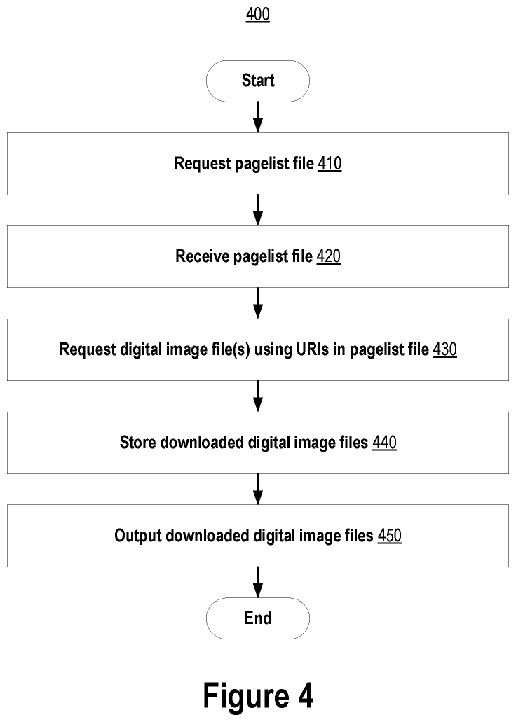

FIG. 4 is a flowchart of an example client process 400 to support just-in-time transmission of digital documents, according to some implementations. The example process 400 of FIG. 4 is described as involving HTTP. However, other application-layer protocols can be utilized in a similar manner.

The client device may request a pagelist file from a server in operation 410. In some implementations, the request is made in accordance with the HTTP protocol or the HTTPS protocol. The request may utilize a URI to an initial pagelist file for a document stored on the server.

The device may receive the pagelist file in operation 420. The client device can include a document player that uses the pagelist file to present the document by requesting digital image files indicated by the URIs in the pagelist file in operation 430. In some implementations, the document player is a plug-in module to or an extension of a standard web browser application. In other implementations, the document player may be a stand-alone application that interfaces with a web browser, or application programming interfaces (APIs) thereof, to receive and present the digital image files using the pagelist file(s). As yet another alternative, the document player may be a special-purpose hardware or firmware component that is embedded in the hardware of the client device.

The document player may cause digital image files from the pagelist file to be downloaded from the server indicated by the URIs. The downloaded digital image file(s) can be stored in storage media of the client device in operation 440. Downloaded digital image file(s) may be deleted immediately after being presented or retained in the storage media for a period of time depending on associated value(s) of the CACHE and/the CACHE_TTL tags in the pagelist file(s).

The downloaded digital image files are output at operation 450. The output may include display of an image on a video display screen part of or electrically coupled to the client device.

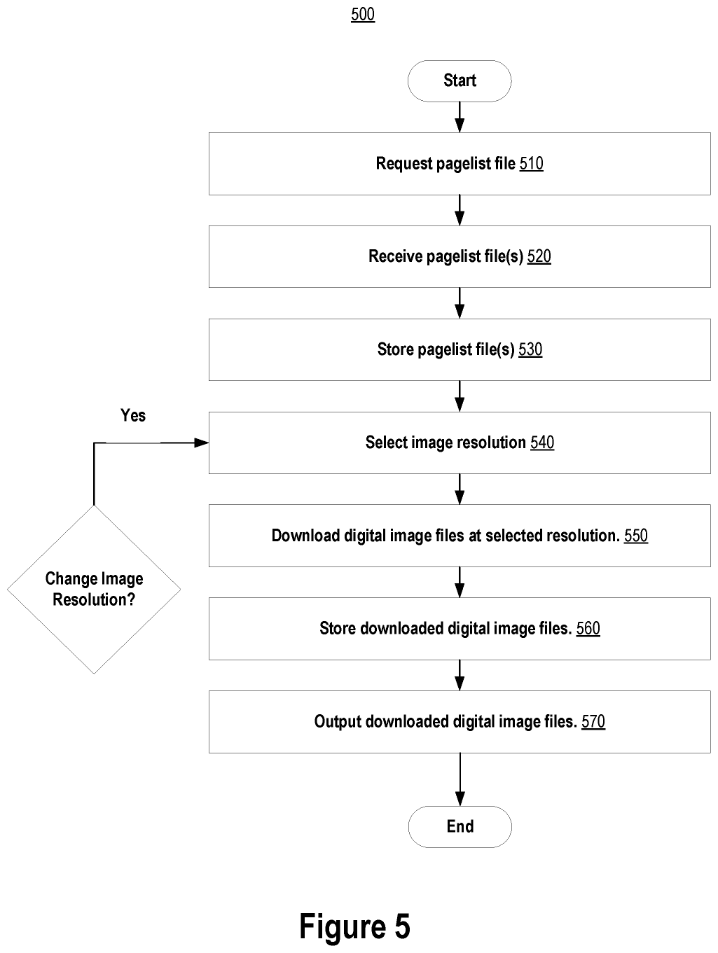

FIG. 5 is a flowchart of an example client process 500 to support just-in-time transmission of digital documents at different image resolutions, according to some implementations.

The client device requests a pagelist file in operation 510. The pagelist file may be retrieved utilizing a URI provided to the client device. In some implementations, the pagelist file includes listings of different digital image files at different image resolutions to provide the same document content at different image resolutions. Stated otherwise, a single pagelist file includes URIs for the digital image files of each of the different image resolutions. In other implementations, the pagelist file is a “master” pagelist file and refers to multiple distinct pagelist files which can be separately downloaded to the client where each distinct pagelist files refers to digital image files of the same document content but at different image resolutions. In either case, the client device can select the appropriate image resolution depending on client conditions such as network bandwidth at the client, display screen size, viewport size, etc.

The pagelist file(s) are received by the client device at operation 520. The received pagelist file(s) may then be stored at the client device at operation 530. The client device may then select the image resolution to be used at operation 540 based upon one or more of a variety of different factors including, but not limited to, current network speed/bandwidth, display screen size, viewport size. In some implementations, the image resolution is selected in response to user input. For example, a lower image resolution may be selected initially when the document content is presented in a social networking news feed or otherwise occupying a relatively smaller portion of the display screen. Then, when the user selects the document content in the news feed with input (e.g., with a mouse click or a touch gesture) or otherwise requests to zoom in on the document content such that the user intends the document content to occupy a relatively portion of the video display screen, then a higher image resolution may be selected. Similarly, when the user no longer wishes for the document content the relatively large portion of the video display screen, a lower image resolution may then be selected. In this way, a just-in-time document presentation experience can be provided utilizing digital images of the document content at different image resolutions.

Digital image files at the selected image resolution are requested from the server utilizing the URIs included in the pagelist files(s) corresponding to the selected image resolution in operation 550. The downloaded digital image files may be stored in storage media at the client device in operation 560. Visible output is provided by the client device utilizing the digital image files in operation 570 and the client device determines whether to change the image resolution.

In some implementations, a client device selects the lowest available image resolution initially. While presenting the document content, the client device can monitor the available network bandwidth (e.g., transfer bit or byte rate) to determine whether the available network bandwidth can support use of higher resolution images for document content presentation. If so, the client device can then select a higher image resolution and download and present the digital media files associated with the higher image resolution in the pagelist file(s). Image resolution fallback can also be supported. If the higher resolution images consume too much bandwidth, the client device can revert to or select a lower image resolution and then download and present the digital media files associated with the lower image resolution in the pagelist file(s).

If the client device changes the image resolution, for example, in response to a change in the available bandwidth or in response to user input, the client device may then utilize a different list of URIs included in a pagelist file that corresponds to the new selected image resolution.

### Example Computer System

Some implementations encompass performance of a method by a computing system having one or more processors and storage media. The one or more processors and the storage media may be provided by one or more computer systems. The storage media of the computing system may store one or more computer programs that include instructions configured to perform the method and that are executed by the one or more processors to perform the method.

For an implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive.

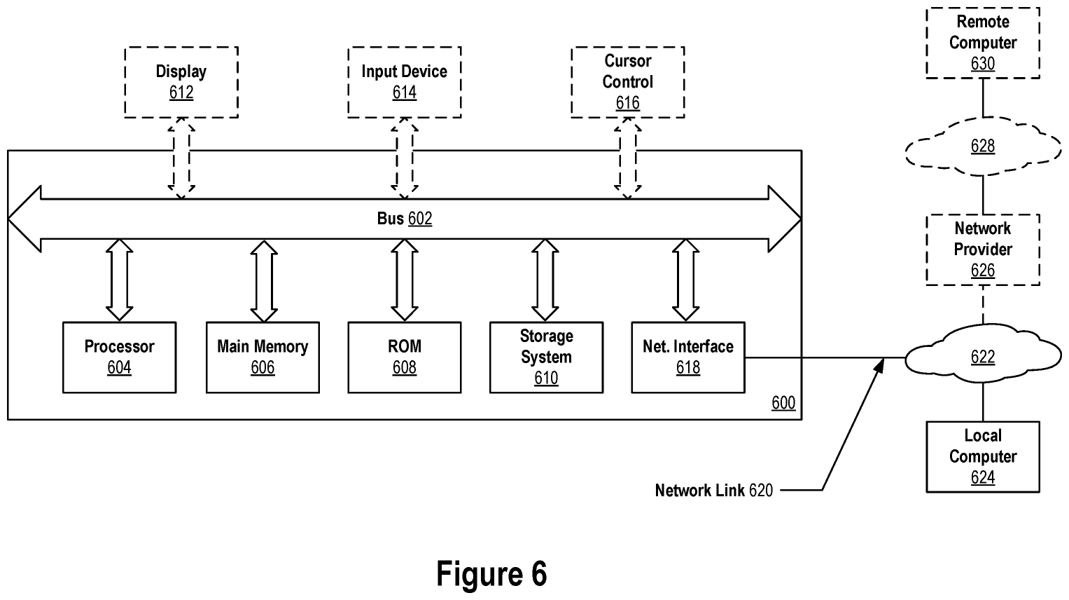

FIG. 6 is a block diagram of an example computer system 600 in accordance with some implementations. Computer system 600 includes bus 602 or other communication mechanism for communicating information, and one or more hardware processors coupled with bus 602 for processing information. Hardware processor 604 may be, for example, a general-purpose microprocessor, a central processing unit (CPU) or a core thereof, a graphics processing unit (GPU), or a system on a chip (SoC).

Computer system 600 also includes a main memory 606, typically implemented by one or more volatile memory devices, coupled to bus 602 for storing information and instructions to be executed by processor 604. Main memory 606 also may be used for storing temporary variables or other intermediate information during execution of instructions by processor 604. Computer system 600 may also include read-only memory (ROM) 608 or other static storage device coupled to bus 602 for storing static information and instructions for processor 604. A storage system 610, typically implemented by one or more non-volatile memory devices, is provided and coupled to bus 602 for storing information and instructions.

Computer system 600 may be coupled via bus 602 to display 612, such as a liquid crystal display (LCD), a light emitting diode (LED) display, or a cathode ray tube (CRT), for displaying information to a computer user. Display 612 may be combined with a touch sensitive surface to form a touch screen display. The touch sensitive surface is an input device for communicating information including direction information and command selections to processor 604 and for controlling cursor movement on display 612 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 614, including alphanumeric and other keys, may be coupled to bus 602 for communicating information and command selections to processor 604.

Another type of user input device may be cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Instructions, when stored in non-transitory storage media accessible to processor 604, such as, for example, main memory 606 or storage system 610, render computer system 600 into a special-purpose machine that is customized to perform the operations specified in the instructions. Alternatively, customized hard-wired logic, one or more ASICs or FPGAs, firmware and/or hardware logic which in combination with the computer system causes or programs computer system 600 to be a special-purpose machine.

A computer-implemented process may be performed by computer system 600 in response to processor 604 executing one or more sequences of one or more instructions contained in main memory 606. Such instructions may be read into main memory 606 from another storage medium, such as storage system 610. Execution of the sequences of instructions contained in main memory 606 causes processor 604 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 610) and/or volatile media (e.g., main memory 606). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 602. Transmission media can also take the form of acoustic or light waves, such as those generated during radio-wave and infra-red data communications.

Computer system 600 also includes a network interface 618 coupled to bus 602. Network interface 618 provides a two-way data communication coupling to a wired or wireless network link 620 that is connected to a local, cellular or mobile network 622. For example, communication interface 618 may be IEEE 802.3 wired “ethernet” card, an IEEE 802.11 wireless local area network (WLAN) card, a IEEE 802.15 wireless personal area network (e.g., Bluetooth) card or a cellular network (e.g., GSM, LTE, etc.) card to provide a data communication connection to a compatible wired or wireless network. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through network 622 to local computer system 624 that is also connected to network 622 or to data communication equipment operated by a network access provider 626 such as, for example, an internet service provider or a cellular network provider. Network access provider 626 in turn provides data communication connectivity to another data communications network 628 (e.g., the internet). Networks 622 and 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the networks 622 and 628, network link 620 and communication interface 618. In the internet example, a remote computer system 630 might transmit a requested code for an application program through network 628, network 622 and communication interface 618. The received code may be executed by processor 604 as it is received, and/or stored in storage device 910, or other non-volatile storage for later execution.

### Terminology

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the various described implementations. The first user interface and the second user interface are both user interfaces, but they are not the same user interface.

The terminology used in the foregoing detailed description and in the appended claims of the various described implementations herein is for the purpose of describing particular implementations only and is not intended to be limiting. As used in the foregoing detailed description and in the appended claims of the various described implementations, the singular forms “a,” “an,” and “the” are intended to include the plural forms as well, unless the context clearly indicates otherwise. It will also be understood that the term “and/or” as used in the foregoing detailed description and in the appended claims refers to and encompasses any and all possible combinations of one or more of the associated listed items. It will be further understood that the terms “includes,” “including,” “comprises,” and/or “comprising,” when used in the foregoing detailed description and in the appended claims, specify the presence of stated features, integers, steps, operations, elements, and/or components, but do not preclude the presence or addition of one or more other features, integers, steps, operations, elements, components, and/or groups thereof.

As used in the foregoing detailed description and in the appended claims, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

For situations in which implementations discussed above collect information about users, the users may be provided with an opportunity to opt in/out of programs or features that may collect personal information. In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

### Extensions and Alternatives

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method performed by a computing device having one or more processors and storage media storing one or more programs, the one or more programs including instructions configured to perform the method, the instructions executed by the one or more processors to perform the method, the method comprising:
receiving, in response to a request, a master pagelist for document content, the master pagelist including a plurality of uniform resource indicators for a plurality of pagelists for the document content;
selecting a first uniform resource indicator of the plurality of uniform resource indicators for the plurality of pagelists for the document content, the first uniform resource indicator referring to a first pagelist of the plurality of pagelists for the document content;
sending the first uniform resource indicator referring to the first pagelist;
receiving the first pagelist; and
processing the first pagelist to cause a download and a presentation of a first digital image referred to in the first pagelist.

2. The method of claim 1, further comprising:
obtaining an indication of a display screen size of a display screen associated with the computing device; and
wherein the selecting the first uniform resource indicator is based at least in part on the indication of the display screen size obtained.

3. The method of claim 1, further comprising:
obtaining an indication of a type of a network connection associated with the computing device; and
wherein the selecting the first uniform resource indicator is based at least in part on the indication of the type of the network connection obtained.

4. The method of claim 3, wherein the indication of the type of the network connection obtained indicates that the type of the network connection is a cellular network connection.

5. The method of claim 1, further comprising:
selecting a second uniform resource indicator (URI) of the plurality of uniform resource indicators (URIs) for the plurality of pagelists for the document, the second uniform resource indicator (URI) referring to a second pagelist of the plurality of pagelists for the document content;
sending the second uniform resource indicator (URI) referring to the second pagelist;
receiving the second pagelist;
detecting a user input during the presentation of the first digital image;
in response to the detecting the user input, causing a download and a presentation of a second digital image;
wherein the first digital image and the second digital image depict a same portion of the document content; and
wherein the first digital image has a different image resolution than the second digital image.

6. The method of claim 5, wherein the user input requests to zoom the presentation of the first digital image.

1. The method of claim 1, wherein:
each uniform resource indicator of the plurality of uniform resource indicators for the plurality of pagelists for the document content is associated in the master pagelist with a respective specification of a respective image resolution; and
the selecting the first uniform resource indicator is based at least in part on the respective specification of the respective image resolution associated in the master pagelist with the first uniform resource indicator.

8. One or more non-transitory computer-readable media comprising one or more programs for execution by a computing system having one or more processors, the one or more programs including instructions configured for:
receiving document content;
transforming the document content into sets of digital images;
generating a master pagelist for the document content, the master pagelist including uniform resource indicators for respective pagelists for the document content, each pagelist of the pagelists including uniform resource indicators for respective digital images of the sets of digital images;
sending, in response to a request, the master pagelist;
sending a first pagelist of the pagelists for the document content in response to a request associated with a uniform resource indicator in the master pagelist for the first pagelist; and
sending a first digital image in response to a request associated with a uniform resource indicator in the first pagelist for the first digital image.

9. The one or more non-transitory computer-readable media of claim 8, wherein the transforming the document content into sets of digital images is based on generating each set of digital images of the sets of digital images at different image resolutions.

10. The one or more non-transitory computer-readable media of claim 8, wherein each uniform resource indicator for the respective pagelists in the master pagelist is associated with a respective specification of a respective different image resolution.

11. The one or more non-transitory computer-readable media of claim 8, the instructions further configured for:
generating a text transcription of at least a portion of the document content; and
wherein the master pagelist includes a uniform resource indicator referring to the text transcription.

12. The one or more non-transitory computer-readable media of claim 8, wherein at least one digital image of the sets of digital images is encrypted; and wherein the master pagelist specifies an encryption method and includes a uniform resource indicator referring to an encryption key for decrypting the at least one digital image.

13. The one or more non-transitory computer-readable media of claim 8, wherein the master pagelist indicates how long a digital image downloaded to a client device is permitted to be cached at the client device.

14. A computing device comprising:
one or more processors;
storage media; and
one or more programs stored in the storage media, the one or more programs including instructions configured for:
receiving, in response to a request, a master pagelist for document content, the master pagelist including a plurality of uniform resource indicators for a plurality of pagelists for the document content;
selecting a first uniform resource indicator of the plurality of uniform resource indicators for the plurality of pagelists for the document content, the first uniform resource indicator referring to a first pagelist of the plurality of pagelists for the document content;
sending the first uniform resource indicator referring to the first pagelist;
receiving the first pagelist; and
processing the first pagelist to cause a download and a presentation of a first digital image referred to in the first pagelist.

15. The computing device of claim 14, the instructions further configured for:
obtaining an indication of a display screen size of a display screen associated with the computing device; and
wherein the selecting the first uniform resource indicator is based at least in part on the indication of the display screen size obtained.

16. The computing device of claim 14, the instructions further configured for:
obtaining an indication of a type of a network connection associated with the computing device; and
wherein the selecting the first uniform resource indicator is based at least in part on the indication of the type of the network connection obtained.

17. The computing device of claim 16, wherein the indication of the type of the network connection obtained indicates that the type of the network connection is a cellular network connection.

18. The computing device of claim 14, the instructions further configured for:
selecting a second uniform resource indicator (URI) of the plurality of uniform resource indicators (URIs) for the plurality of pagelists for the document, the second uniform resource indicator (URI) referring to a second pagelist of the plurality of pagelists for the document content;
sending the second uniform resource indicator (URI) referring to the second pagelist;
receiving the second pagelist;
detecting a user input during the presentation of the first digital image;
in response to the detecting the user input, causing a download and a presentation of a second digital image;
wherein the first digital image and the second digital image depict a same portion of the document content; and
wherein the first digital image has a different image resolution than the second digital image.

19. The computing device of claim 18, wherein the user input requests to zoom the presentation of the first digital image.

20. The computing device of claim 14, wherein:
each uniform resource indicator of the plurality of uniform resource indicators for the plurality of pagelists for the document content is associated in the master pagelist with a respective specification of a respective image resolution; and
the selecting the first uniform resource indicator is based at least in part on the respective specification of the respective image resolution associated in the master pagelist with the first uniform resource indicator.
